(19) United States
(12) Patent Application Publication
(10) Pub. No.: US 2023/0337594 A1
(43) Pub. Date: Oct. 26, 2023

(54) Truss-less Greenhouse Structure with a Transparent Solar Panel Roof

(71) Applicant: Charles L. Stricklan, Scottsdale, AZ (US)

(72) Inventor: Charles L. Stricklan, Scottsdale, AZ (US)

(21) Appl. No.: 18/307,597

(22) Filed: Apr. 26, 2023

Related U.S. Application Data
(60) Provisional application No. 63/334,993, filed on Apr. 26, 2022.

(51) Int. Cl. A01G 9/24; A01G 9/14; E04B 1/19

(52) U.S. Cl. CPC A01G 9/243; A01G 9/14; E04B 1/19; E04B 2001/199; E04B 2001/1993

(57) ABSTRACT

A central-loadbearing greenhouse includes a first column system, a second column system, at least one intermediate column system, a plurality of roof supports, and a transparent solar roof. The first column system and the second column system are diametrically opposed to each other about the intermediate column system. A fixed end for the first column system, the intermediate column system, and the second column system are linearly mounted offset of each other. The plurality of roof supports is linearly extended from the first column system to the second column system. The plurality of roof supports is evenly distributed across an elevated end of the first column system, the intermediate column system, and the second column system. The plurality of roof supports is adjacently mounted onto the first column system, the intermediate column system, and the second column system. The transparent solar roof is mounted to the plurality of roof supports.

The current application claims a priority to the U.S. provisional patent application Ser. No. 63/334,993 filed on Apr. 26, 2022.

### FIELD OF THE INVENTION

The present invention generally relates to a solar greenhouse. More specifically, the present invention is a truss-less greenhouse structure with a transparent solar panel roof that utilizes a central structural support system to eliminate roof trusses generally found in existing greenhouses.

### BACKGROUND OF THE INVENTION

Standard overhead roof structures generally utilize a traditional truss system that requires additional side wall support structures and a centrally based support beam. These roof structures are used to create greenhouses that cultivate and grow various plants in controlled environments. Some greenhouse manufacturers have attempted to equip their structures with conventional solar panels to utilize sunlight to harvest power for later or immediate use. These greenhouse structures utilize a standard solar panel that blocks any natural light from fully passing through. This design limits the amount of natural light entering the greenhouse thus shading the plants and decreasing the growth and production of the plants.

An objective of the present invention is to replace the “current” design of all greenhouses that utilize exterior support posts, truss systems, and conventional roof of glass or polycarbonate. More specifically, the present invention utilizes a center weighted weightbearing column system to totally carry the total weight of the roof and walls. The present invention also functions as a true solar greenhouse, allowing full penetration of natural light while still generating solar power from the surrounding natural light by incorporating clear or slightly tinted solar PVC panels. The present invention intends to provide users with a greenhouse structure that improves harvest production while generating renewable energy through transparent solar roof panels. The present invention can be built with side wall or without side wall thus allowing greater flexibility for growers. Furthermore, the renewable energy is recycled back into the greenhouse to power any electrical components such as irrigation systems, fans, lighting systems, fertilizing systems, venting systems, etc.

### SUMMARY OF THE INVENTION

The present invention is a truss-less greenhouse structure with transparent solar panels to help with increasing harvesting production, produce clean renewable energy from the sun to operate the greenhouse and minimize the amount of water necessary for plant growth by up to 90%. The present invention seeks to provide users with a device that can be used to water, fertilize, monitor, and provide light to plants within. In order to accomplish this the present invention comprises a base that utilizes a central vertical pillar with a curved beam or slanted beams creating a central corridor to aid harvesting process. Additionally, the central vertical pillars and the roof beams have been engineered stronger than a typical “truss-roof” greenhouse. Resultantly, a typical 100′ long single greenhouse is configured with the central vertical pillars and the roof beams that are placed at 25-foot intervals to minimize interference of structural elements. Due to the fact that the present invention does not use traditional roof trusses, the present invention uses approximately 40% less steel, reducing the amount of moisture that generally retains within trusses. Further, the roof consist of transparent solar panels and harvests solar energy while allowing natural light to penetrate. Additionally, the plurality of sides keeps the plants within, separated from the outside conditions thus creating a totally controlled environment for growing plants. Additionally, multiple greenhouses can be constructed via a gutter system that connects each of the buildings into each other. The present invention does not require posts where the buildings are connected to each other as the loads are fully carried by the central vertical pillars and the roof beams. Thus, the present invention is a solar greenhouse that utilizes a unique structure with an accompanying plurality of transparent solar panels to allow natural light to pass through into the present invention and for natural light to be utilized as a renewable energy source.

### BRIEF DESCRIPTION OF THE DRAWINGS

FIG. 1 is a top perspective view of the central-loadbearing greenhouse.

FIG. 2 is a top perspective view of the first column system, the second column system, the at least one intermediate column system, and the plurality of roof supports of the present invention.

FIG. 3 is a top perspective view of the first column system, the second column system, the at least one intermediate column system, the plurality of roof supports, and the transparent solar roof of the present invention.

FIG. 4 is a front view of the first column system, the second column system, the at least one intermediate column system, the plurality of roof supports, and the transparent solar roof of the present invention.

FIG. 5 is a front view of the first column system of the present invention.

FIG. 6 is a front view of the second column system of the present invention.

FIG. 7 is a front view of the intermediate column system of the present invention.

FIG. 8 is a front view of the first column system, the second column system, the at least one intermediate column system, and the plurality of roof supports of the present invention, showing the opening of the set of left ridge-supports and the set of right ridge-supports.

FIG. 9 is a front view of the first column system, the second column system, the at least one intermediate column system, the plurality of roof supports, and the transparent solar roof of the present invention, showing the opening of the left retractable-paneled section and the right retractable-paneled section.

FIG. 10 is a top perspective view of the first column system, the second column system, the at least one intermediate column system, the plurality of roof supports, the transparent solar roof, the first end-frame, the second end-frame, first transparent wall, and the second transparent wall of the present invention.

FIG. 11 is a top perspective view of the first column system, the second column system, the at least one intermediate column system, the plurality of roof supports, the transparent solar roof, the first end-frame, the second end-frame, first transparent wall, the second transparent wall, the left frame, and the left transparent wall of the present invention.

FIG. 12 is a top perspective view of the first column system, the second column system, the at least one intermediate column system, the plurality of roof supports, the transparent solar roof, the first end-frame, the second end-frame, first transparent wall, the second transparent wall, the right frame, and the right transparent wall of the present invention.

### DETAIL DESCRIPTIONS OF THE INVENTION

All illustrations of the drawings are for the purpose of describing selected versions of the present invention and are not intended to limit the scope of the present invention.

The present invention is a truss-less greenhouse structure with transparent solar panels to provide users with a greenhouse with a unique structure that does not rely on peripheral support, outside walls, or trusses and provides unlimited free power from the sun. The present invention intends to provide users with a structure that can utilize solar power for renewable energy while allowing natural light to easily penetrate through the roof. The components and their configuration of the present invention allow for easy maintenance and harvesting as the loadbearing structures are centrally positioned within the present invention. The present invention is explained in relation to at least one central-loadbearing greenhouse 1, wherein the at least one central-loadbearing greenhouse 1 can be a single greenhouse or multiple greenhouses that are connected to each other.

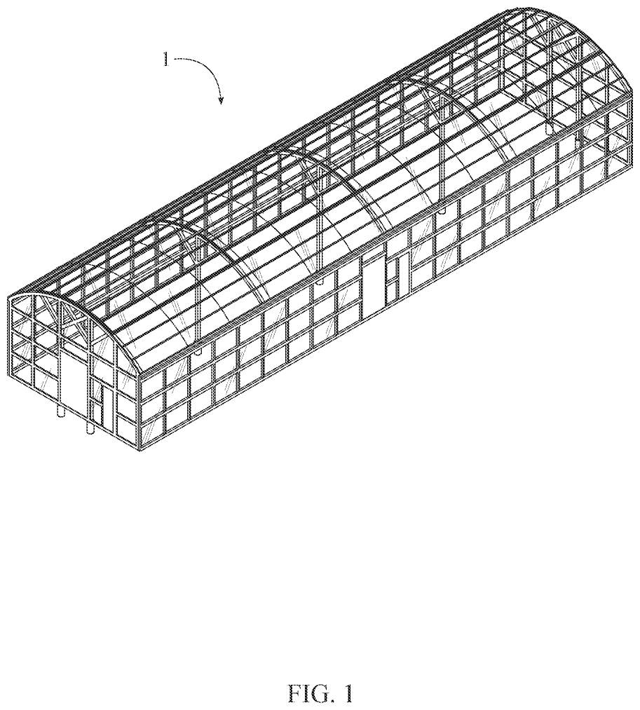

As shown in FIGS. 1-3, the at least one central-loadbearing greenhouse 1 comprises a first column system 2, a second column system 11, at least one intermediate column system 12, a plurality of roof supports 14, and a transparent solar roof 19. In reference to the general configuration of the present invention, the first column system 2 and the second column system 11 are diametrically opposed to each other about the at least one intermediate column system 12 as each of the column systems function as a loadbearing structure that distribute the weight of the roof. A fixed end 3 of the first column system 2, a fixed end 3 of the at least one intermediate column system 12, and a fixed end 3 of the second column system 11 are linearly mounted offset of each other. In other words, the fixed end 3 of the first column system 2, the fixed end 3 of the at least one intermediate column system 12, and the fixed end 3 of the second column system 11 are centrally positioned within the present invention so that each corresponding fixed end 3 can be mounted to the ground surface or the foundation. The plurality of roof supports 14 is linearly extended from the first column system 2 to the second column system 11, wherein the plurality of roof supports 14 is evenly distributed across an elevated end 4 of the first column system 2, an elevated end 4 of the at least one intermediate column system 12, and an elevated end 4 of the second column system 11. The plurality of roof supports 14 is adjacently mounted to a roof structure 7 of the first column system 2, a roof structure 7 of the at least one intermediate column system 12, and a roof structure 7 of the second column system 11. In other words, the plurality of roof structure 7s is able to structurally strengthen the first column system 2, the at least one intermediate column system 12, and the second column system 11 into each other to minimize lateral movements of each corresponding column system. The transparent solar roof 19 is mounted onto the plurality of roof supports 14 as the roofing system.

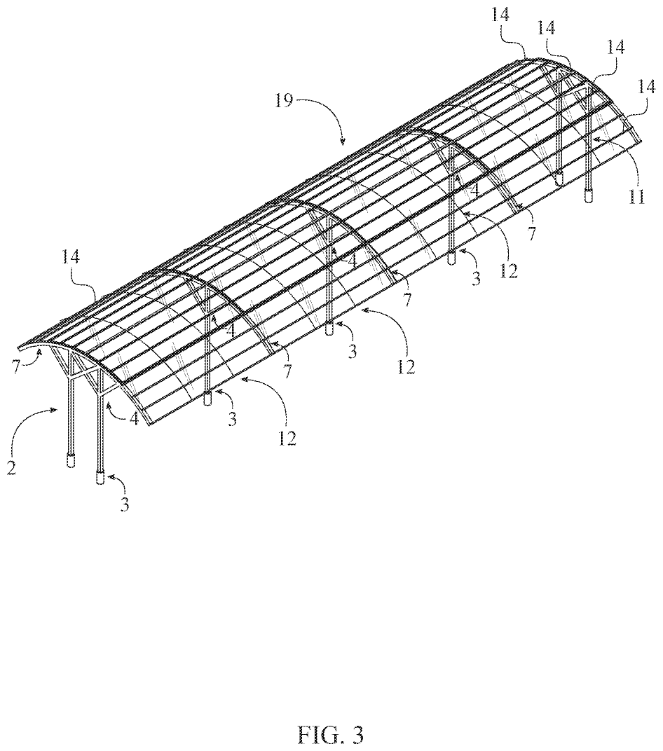

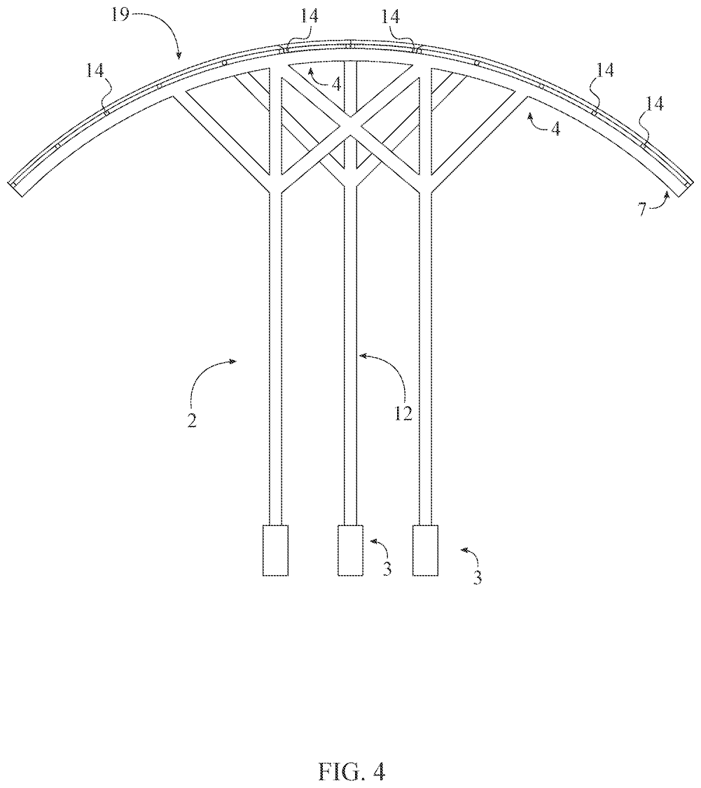

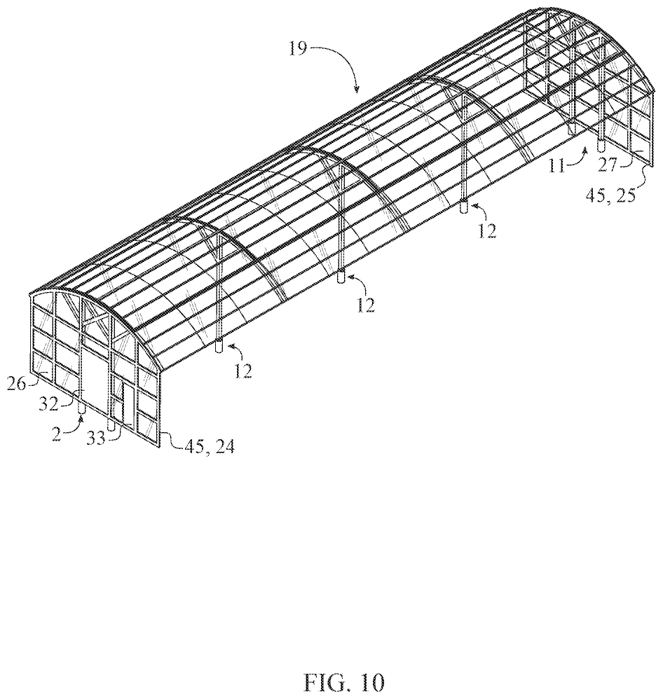

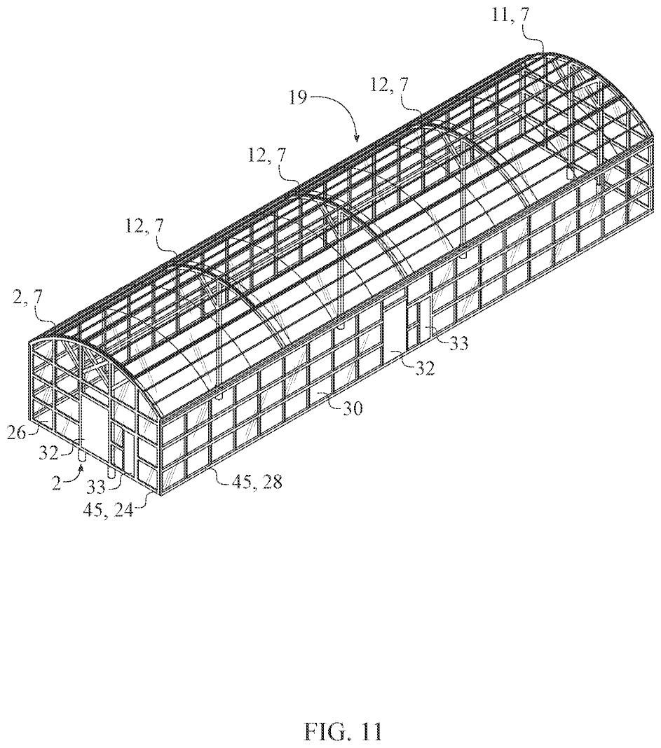

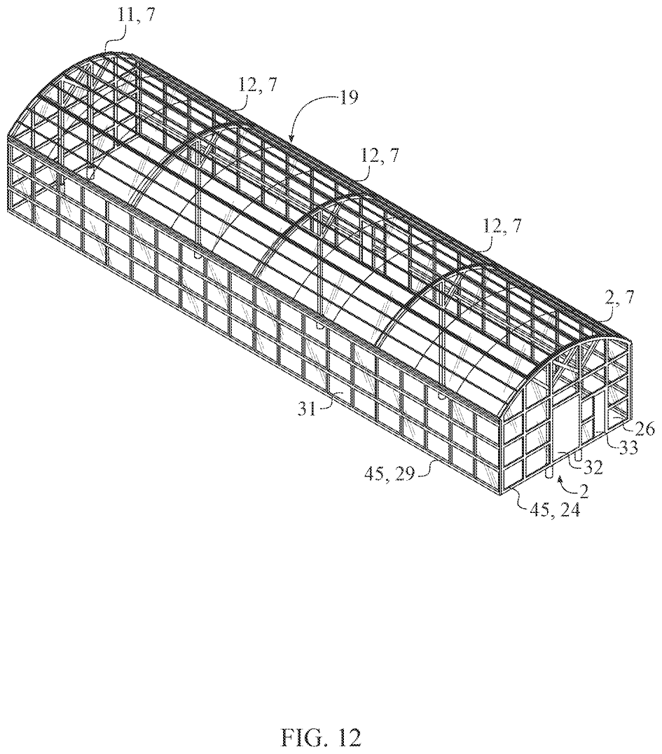

As shown in FIG. 3 and FIG. 4, when the present invention is configured with the first column system 2, the second column system 11, the at least one intermediate column system 12, the plurality of roof supports 14, and the transparent solar roof 19, the present invention is recognized as a “hoop house”. As shown in FIGS. 10-12, the present invention may further comprise a lateral frame 45, a first transparent wall 26, a second transparent wall 27, a left transparent wall 30, and a right transparent wall 31. More specifically, the lateral frame 45 is laterally mounted to the first column system 2, the second column system 11, the at least one intermediate column system 12, the plurality of roof supports 14 so that the first transparent wall 26, the second transparent wall 27, the left transparent wall 30, and the right transparent wall 31 can be mounted to the lateral frame 45. As a result, when the present invention is configured with the first column system 2, the second column system 11, the at least one intermediate column system 12, the plurality of roof supports 14, the transparent solar roof 19, the lateral frame 45, the first transparent wall 26, the second transparent wall 27, the left transparent wall 30, and the right transparent wall 31, the present invention is recognized as a “greenhouse”.

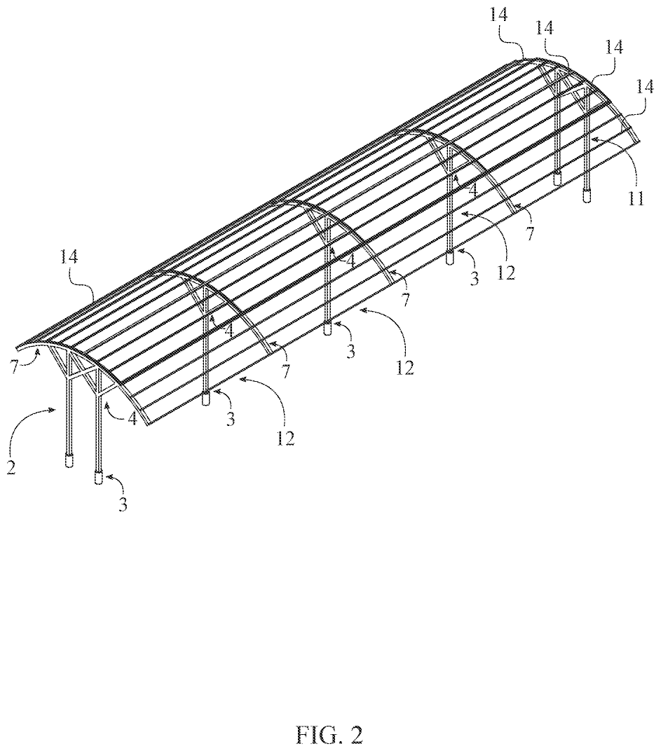

As shown in FIG. 2, the first column system 2 and the second column system 11 function as the outermost load bearing structures within the present invention. The at least one intermediate column system 12 functions as the inner load bearing structures within the present invention. In other words, the total length of the present invention is measured from the first column system 2 to the second column system 11 as the at least one intermediate column system 12 is positioned in between the first column system 2 and the second column system 11. For example, when a preferred embodiment of the present invention is 100 foot (ft) long, the first column system 2 and the second column system 11 are mounted 100 ft apart as the at least one intermediate column system 12 is spaced every 25 ft. In other words, a first intermediate column of the at least one intermediate column system 12 is mounted the 25 ft from the first column system 2, a second intermediate column of the at least one intermediate column system 12 is mounted 50 ft from the first column system 2, a third intermediate column of the at least one intermediate column system 12 is mounted 75 ft from the first column system 2.

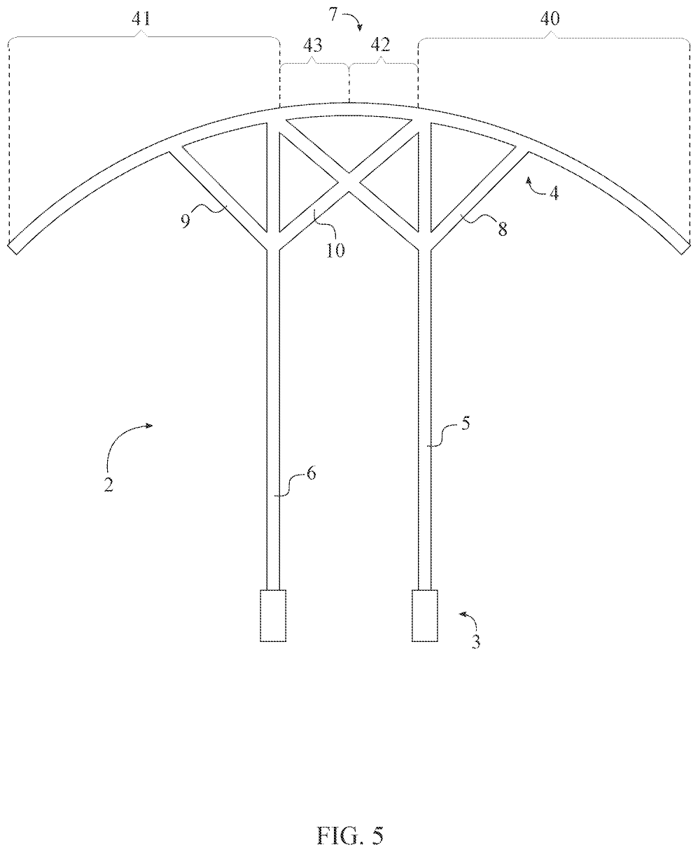

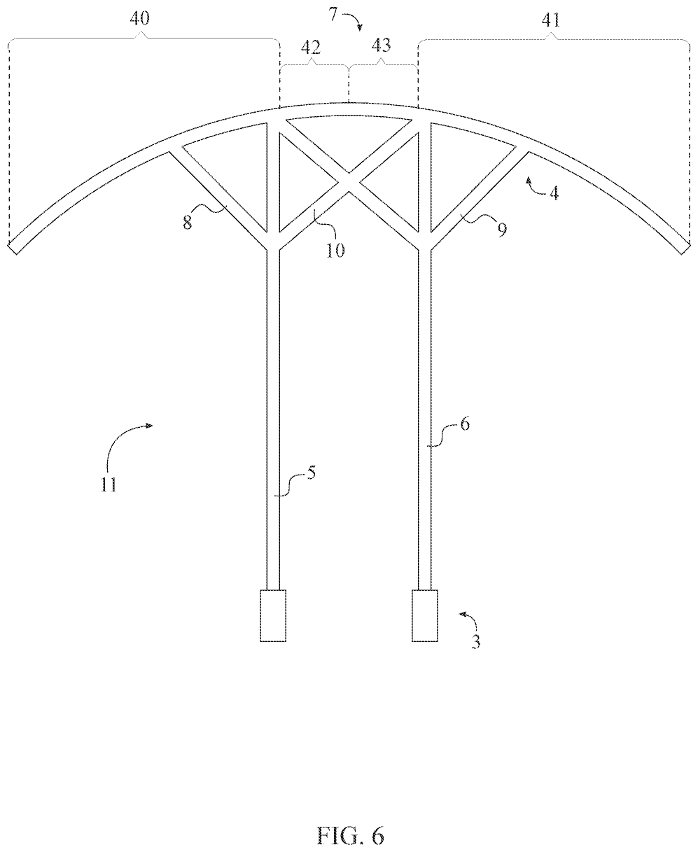

As shown in FIG. 5 and FIG. 6, the first column system 2 and the second column system 11 may each comprise a left column 5, a right column 6, a left outer-brace 8, a right outer-brace 9, and a X-brace 10. The left column 5 is positioned parallel to the right column 6 and positioned offset of each other. The left column 5 and the right column 6 function as vertical members so that the height of the present invention can be determined. The roof structure 7 is terminally mounted to the left column 5 and the right column 6 and centrally positioned to the left column 5 and the right column 6. The shape of the roof structure 7 determines the actual shape of the transparent solar roof 19 as the plurality of roof supports 14 are distributed perpendicular to the orientation of the roof structure 7. More specifically, the roof structure 7 may comprise a left overhanging section 40, a right overhanging section 41, a central left section 42, and a central right section 43 as shown in FIG. 5 and FIG. 6. The central left section 42 and the central right section 43 are positioned adjacent to each other and supported by the left outer-brace 8 and the right outer-brace 9. The left overhanging section 40 is positioned adjacent to the central left section 42 and positioned opposite of the central right section 43. The right overhanging section 41 is positioned adjacent to the central right section 43 and positioned opposite of the central left section 42. The left outer-brace 8 is outwardly oriented away from the right column 6 and angularly mounted to the roof structure 7 and the left column 5. As a result, the left outer-brace 8 is able to structurally support the central left section 42 and the left overhanging section 40. The right outer-brace 9 is outwardly oriented away from the left column 5 and angularly mounted to the roof structure 7 and the right column 6. As a result, the right outer-brace 9 is able to structurally support the central right section 43 and the right overhanging section 41. The X-brace 10 is positioned adjacent to the roof structure 7 and positioned in between the left column 5 and the right column 6. Furthermore, the X-brace 10 is terminally connected to the left column 5, the right column 6, and the roof structure 7 so the left column 5 and the right column 6 can be further strengthened. In other words, an upper left-end of the X-brace 10 is connected to the left column 5 and/or the roof structure 7, an upper right-end of the X-brace 10 is connected to the right column 6 and/or the roof structure 7, a lower left-end of the X-brace 10 is connected to the left column 5, and a lower right-end of the X-brace 10 is connected to the right column 6. Due to the four connection points, the X-brace 10 is able to prevent bending of the left column 5 and the right column 6 that can take place due to the weight of the transparent solar roof 19.

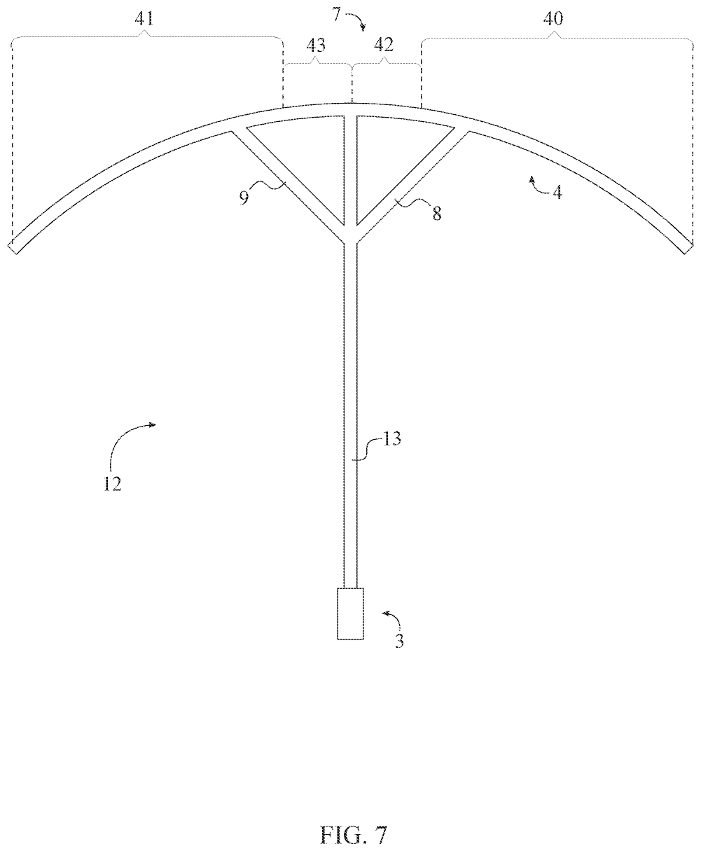

As shown in FIG. 7, the at least one intermediate column system 12 may comprise a support column 13, a left outer-brace 8, and a right outer-brace 9. The support column 13 is positioned parallel to the left column 5 and the right column 6 as the right support functions as a vertical member that determine the height of the present invention. The roof structure 7 is terminally mounted to the support column 13 and centrally positioned to the support column 13. The shape of the roof structure 7 determines the actual shape of the transparent solar roof 19 as the plurality of roof supports 14 are distributed perpendicular to the orientation of the roof structure 7. More specifically, the roof structure 7 may comprise the left overhanging section 40, the right overhanging section 41, the central left section 42, and the central right section 43 as shown in FIG. 1. The central left section 42 and the central right section 43 are positioned adjacent to each other and supported by the left outer-brace 8 and the right outer-brace 9. The left overhanging section 40 is positioned adjacent to the central left section 42 and positioned opposite of the central right section 43. The right overhanging section 41 is positioned adjacent to the central right section 43 and positioned opposite of the central left section 42. The left outer-brace 8 is outwardly oriented away from the support column 13 and angularly mounted to the roof structure 7 and the support column 13. As a result, the left outer-brace 8 is able to structurally support the central left section 42 and the left overhanging section 40. The right outer-brace 9 is outwardly oriented away from the support column 13 and angularly mounted to the roof structure 7 and the support column 13. As a result, the right outer-brace 9 is able to structurally support the central right section 43 and the right overhanging section 41.

As shown in FIGS. 5-7, the roof structure 7 of the first column system 2 is preferably an arch body. The roof structure 7 of the second column system 11 is also an arch body. The roof structure 7 of the at least one intermediate column is also an arch body. The preferred arch body of the root structure is also known as “Roman-arch design” within the industry as each arch body of the corresponding column system is similar to each other. In order to satisfy industry standards, the linear length of the roof structure 7 is approximately 25 ft. Alternatively, the roof structure 7 can also be a pitched roof without deviating from the scoop of the functionality. Furthermore, the fixed end 3 of the first column system 2, the fixed end 3 of the at least one intermediate column system 12, and the fixed end 3 of the second column system 11 are mounted to the ground surface or the foundation via industry standard mounting methods. For example, the fixed end 3 of each corresponding column system can be directly buried into the ground and secured with concrete or mounted atop a concrete columns via bracketing or fastening system.

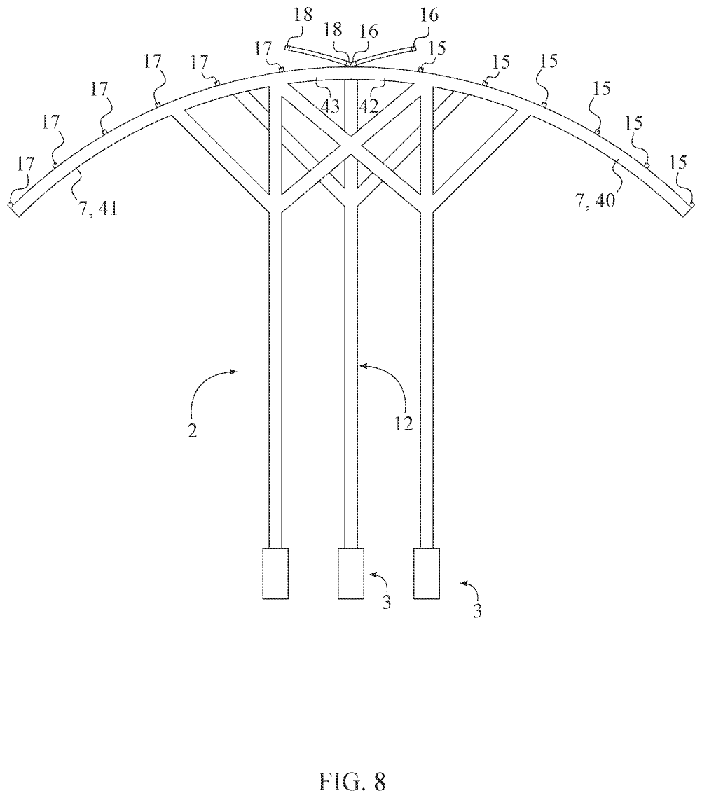

The plurality of roof supports 14 is a set of elongated structural members so that the first column system 2, the second column system 11, and the at least one intermediate column system 12 can be mounted to each other. Furthermore, the plurality of roof supports 14 provides a surface area for the transparent solar roof 19 to be mounted. As shown in FIG. 2 and FIG. 8, the plurality of roof supports 14 may comprise a set of left outer-supports 15, a set of left ridge-supports 16, a set of right outer-supports 17, and a set of right ridge-supports 18. More specifically, the set of left outer-supports 15 is evenly distributed across the left overhanging section 40 and adjacently mounted the left overhanging section 40. The set of right outer-supports 17 is evenly distributed across the right overhanging section 41 and adjacently mounted the right overhanging section 41. The set of left ridge-supports 16 is evenly distributed across the central left section 42 and retractably mounted to the central left section 42. As a result, the set of left ridge-supports 16 is able to function as a first window to selectively open and close the left half of the transparent solar roof 19. The set of right ridge-supports 18 is evenly distributed across the central right section 43 and retractably mounted to the central right section 43. As a result, the set of right ridge-supports 18 is able to function as a second window to selectively open and close the right half of the transparent solar roof 19.

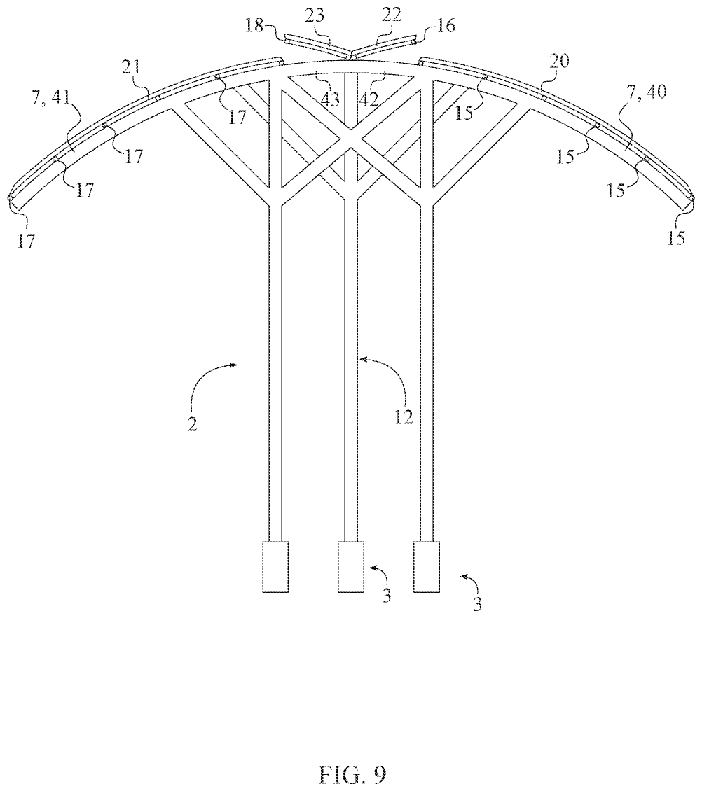

In transparent solar roof 19 functions as the renewable energy generation unit while functioning as a traditional greenhouse roof. The renewable energy is stored within at least one battery so that the stored electrical energy is able to electrically power electrical components that are related to the greenhouse. For example, the transparent solar roof 19 is able to electrically operate irrigation systems, fans, lighting systems, venting systems, fertilization systems, and other related electrical components. As shown in FIG. 9, the transparent solar roof 19 may comprise a left fixed-paneled section 20, a right fixed-paneled section 21, a left retractable-paneled section 22, and a right retractable-paneled section 23. More specifically, the left fixed-paneled section 20 is mounted to the set of left outer-supports 15 thus allowing the left fixed-paneled section to function as the traditional greenhouse roof and the renewable energy generating unit. The right fixed-paneled section 21 is mounted to the set of right outer-supports 17 thus allowing the right fixed-paneled section 21 to function as the traditional greenhouse roof and the renewable energy generating unit. The left retractable-paneled section 22 is mounted to the set of left ridge-supports 16 so that the left retractable-paneled section 22 is able to function as the traditional greenhouse roof, the renewable energy generating unit, and a left roof ventilating panel. The right retractable-paneled section 23 is mounted to the set of right ridge-supports 18 so that the right retractable-paneled section 23 is able to function as the traditional greenhouse roof, the renewable energy generating unit, and a right roof ventilating panel.

In reference to FIGS. 10-12, the lateral frame 45 that is perimetrically positioned around the first column system 2, the second column system 11, and the at least one intermediate column system 12 may comprise a first end-frame 24, a second end-frame 25, a left frame 28, and a right frame 29. The first end-frame 24 is externally mounted to the first column system 2 thus defining the front outer frame of the present invention. The first transparent wall 26 can then be externally mounted to the first end-frame 24 to complete the front end-wall. The second end-frame 25 is externally mounted to the second column system 11 thus defining the rear outer frame of the present invention. The second transparent wall 27 can then be externally mounted to the second end-frame 25 to complete the rear end-wall. The left frame 28 and the right frame 29 are positioned of each other about the first column system 2 so that the left side and the right side of the present invention can be laterally covered. The left frame 28 is externally mounted to the roof structure 7 of the first column system 2, the roof structure 7 of the at least one intermediate column system 12, the roof structure 7 of the second column system 11, the first end-frame 24, and the second end-frame 25. More specifically, the left frame 28 is laterally mounted to the left overhanging section 40 of the first column system 2, the left overhanging section 40 of the at least one intermediate column system 12, the left overhanging section 40 of the second column system 11, the first end-frame 24, and the second end-frame 25. The right frame 29 is externally mounted to the roof structure 7 of the first column system 2, the roof structure 7 of the at least one intermediate column system 12, the roof structure 7 of the second column system 11, the first end-frame 24, and the second end-frame 25. More specifically, the right frame 29 is laterally mounted to the right overhanging section 41 of the first column system 2, the right overhanging section 41 of the at least one intermediate column system 12, the right overhanging section 41 of the second column system 11, the first end-frame 24, and the second end-frame 25. Once the left frame 28 and the right frame 29 are mounted opposite of each other, the left transparent wall 30 is externally mounted to the left frame 28 to complete the left wall, and the right transparent wall 31 is externally mounted to the right frame 29 to complete the right wall. Furthermore, the first transparent wall 26, the second transparent wall 27, the left transparent wall 30, and the right transparent wall 31 can be a single transparent panel that allows the penetration of light or multiple panels that allow penetration of light.

In reference to FIGS. 10-12, the present invention may further comprise at least one roll up door 32 and at least one man door 33. More specifically, the roll up door 32 is utilized to move equipment, vehicles, and any other lager objects in and out from the present invention. The roll up door 32 is integrated into the lateral frame 45, wherein the exact positioning of the roll up can be changed upon client preference or industry requirements. Preferably, the at least one roll up door 32 is connected to the first end-frame 24. However, the at least one roll up door 32 can be connected to the first end-frame 24, the second end-frame 25, the left frame 28, or the right frame 29. The man door 33 is utilized as a moveable barrier that allow human entry to the present invention. The man door 33 is integrated into the lateral frame 45, wherein the exact positioning of the man can be changed upon client preference or industry requirements. Preferably, the at least one man door 33 is connected adjacent to the at least one roll up door 32. However, the at least one man door 33 can be connected to the first end-frame 24, the second end-frame 25, the left frame 28, or the right frame 29.

When the at least one central-loadbearing greenhouse 1 is configured as the multiple greenhouses that are connected to each other, the present invention utilizes a gutter system to connect each greenhouse into each other. Furthermore, any inside walls within the multiple greenhouses are eliminated to maximize the usable space. For example, when a first greenhouse and a second greenhouse are connected to each other, and the second greenhouse is outwardly extended from the left overhanging section 40 of the first greenhouse, the left frame 28 of the first greenhouse and the left transparent wall of the first greenhouse are eliminated along with the right frame 29 of the second greenhouse and the right transparent wall 31 of the second greenhouse. The same process can be continued for any number of greenhouses without deviating from the scope of the functionality.

Although the invention has been explained in relation to its preferred embodiment, it is to be understood that many other possible modifications and variations can be made without departing from the spirit and scope of the invention as hereinafter claimed.

What is claimed is:

1. A truss-less greenhouse structure with a transparent solar panel roof comprising:
at least one central-loadbearing greenhouse;
the at least one central-loadbearing greenhouse comprising a first column system, a second column system, at least one intermediate column system, a plurality of roof supports, and a transparent solar roof;
the first column system and the second column system being diametrically opposed to each other about the at least one intermediate column system;
a fixed end of the first column system, a fixed end of the at least one intermediate column system, and a fixed end of the second column system being linearly mounted offset of each other;
the plurality of roof supports being linearly extended from the first column system to the second column system;
the plurality of roof supports being evenly distributed across an elevated end of the first column system, an elevated end of the at least one intermediate column system, and an elevated end of the second column system;
the plurality of roof supports being adjacently mounted onto a roof structure of the first column system, a roof structure of the at least one intermediate column system, and a roof structure of the second column system; and
the transparent solar roof being mounted onto the plurality of roof supports.

2. The truss-less greenhouse structure with a transparent solar panel roof as claimed in claim 1 comprising:
the first column system and the second column system each comprising a left column, a right column, a left outer-brace, a right outer-brace, and a X-brace;
the left column being positioned parallel to the right column;
the roof structure being terminally mounted to the left column and the right column;
the roof structure being centrally positioned to the left column and the right column;
the left outer-brace being outwardly oriented away from the right column;
the left outer-brace being angularly mounted to the roof structure and the left column;
the right outer-brace being outwardly oriented away from the left column;
the right outer-brace being angularly mounted to the roof structure and the right column;
the X-brace being positioned adjacent to the roof structure;
the X-brace being positioned in between the left column and the right column; and
the X-brace being terminally connected to the left column, the right column, and the roof structure.

3. The truss-less greenhouse structure with a transparent solar panel roof as claimed in claim 1, wherein the roof structure of the first column system is an arch body.

4. The truss-less greenhouse structure with a transparent solar panel roof as claimed in claim 1, wherein the roof structure of the second column system is an arch body.

5. The truss-less greenhouse structure with a transparent solar panel roof as claimed in claim 1 comprising:
the at least one intermediate column system comprising a support column, a left outer-brace, and a right outer-brace;
the roof structure being terminally mounted to the support column;
the roof structure being centrally positioned to the support column;
the left outer-brace and the right outer-brace being outwardly oriented away from the support column;
the left outer-brace being angularly mounted to the roof structure and the support column; and
the right outer-brace being angularly mounted to the roof structure and the support column.

6. The truss-less greenhouse structure with a transparent solar panel roof as claimed in claim 1, wherein the roof structure of the at least one intermediate column system is an arch body.

7. The truss-less greenhouse structure with a transparent solar panel roof as claimed in claim 1 comprising:
the roof structure comprising a left overhanging section, a right overhanging section, a central left section, and a central right section;
the central left section and the central right section being positioned adjacent to each other;
the left overhanging section being positioned adjacent to the central left section, opposite of the central right section; and
the right overhanging section being positioned adjacent to the central right section, opposite of the central left section.

8. The truss-less greenhouse structure with a transparent solar panel roof as claimed in claim 1 comprising:
the plurality of roof supports comprising a set of left outer-supports, a set of left ridge-supports, a set of right outer-supports, and a set of right ridge-supports;
the roof structure comprising a left overhanging section, a right overhanging section, a central left section, and a central right section;
the set of left outer-supports being evenly distributed across the left overhanging section;
the set of left outer-supports being adjacently mounted the left overhanging section;
the set of right outer-supports being evenly distributed across the right overhanging section;
the set of right outer-supports being adjacently mounted the right overhanging section;
the set of left ridge-supports being evenly distributed across the central left section;
the set of left ridge-supports being retractably mounted the central left section;
the set of right ridge-supports being evenly distributed across the central right section; and
the set of right ridge-supports being retractably mounted the central right section.

9. The truss-less greenhouse structure with a transparent solar panel roof as claimed in claim 1 comprising:
the transparent solar roof comprising a left fixed-paneled section, a right fixed-paneled section, a left retractable-paneled section, and a right retractable-paneled section;
the plurality of roof supports comprising a set of left outer-supports, a set of left ridge-supports, a set of right outer-supports, and a set of right ridge-supports;
the left fixed-paneled section being mounted to the set of left outer-supports;
the right fixed-paneled section being mounted to the set of right outer-supports;
the left retractable-paneled section being mounted to the set of left ridge-supports; and
the right retractable-paneled section being mounted to the set of right ridge-supports.

10. The truss-less greenhouse structure with a transparent solar panel roof as claimed in claim 1 comprising:
a lateral frame;
a first transparent wall;
a second transparent wall;
a left transparent wall;
a right transparent wall;
the lateral frame comprising a first end-frame, a second end-frame, a left frame, and a right frame;
the first end-frame being externally mounted to the first column system;
the second end-frame being externally mounted to the second column system;
the first transparent wall being externally mounted to the first end-frame;
the second transparent wall being externally mounted to the second end-frame;
the left frame and the right frame being oppositely positioned of each other about the first column system;
the left frame being externally mounted to the roof structure of the first column system, the roof structure of the at least one intermediate column system, the roof structure of the second column system, the first end-frame, and the second end-frame;
the right frame being externally mounted to the roof structure of the first column system, the roof structure of the at least one intermediate column system, the roof structure of the second column system, the first end-frame, and the second end-frame;
the left transparent wall being externally mounted to the left frame; and
the right transparent wall being externally mounted to the right frame.

11. The truss-less greenhouse structure with a transparent solar panel roof as claimed in claim 1 comprising:
at least one roll up door;
a lateral frame; and
the roll up door being integrated into the lateral frame.

12. The truss-less greenhouse structure with a transparent solar panel roof as claimed in claim 1 comprising:
at least one man door;
a lateral frame; and
the man door being integrated into the lateral frame.

13. A truss-less greenhouse structure with a transparent solar panel roof comprising:
at least one central-loadbearing greenhouse;
the at least one central-loadbearing greenhouse comprising a first column system, a second column system, at least one intermediate column system, a plurality of roof supports, and a transparent solar roof;
the first column system and the second column system each comprising a left column, a right column, a roof structure, a left outer-brace, a right outer-brace, and a X-brace;
the first column system and the second column system being diametrically opposed to each other about the at least one intermediate column system;
a fixed end of the first column system, a fixed end of the at least one intermediate column system, and a fixed end of the second column system being linearly mounted offset of each other;
the left column being positioned parallel to the right column;
the roof structure being terminally mounted to the left column and the right column;
the roof structure being centrally positioned to the left column and the right column;
the left outer-brace being outwardly oriented away from the right column;
the left outer-brace being angularly mounted to the roof structure and the left column;
the right outer-brace being outwardly oriented away from the left column;
the right outer-brace being angularly mounted to the roof structure and the right column;
the X-brace being positioned adjacent to the roof structure;
the X-brace being positioned in between the left column and the right column;
the X-brace being terminally connected to the left column, the right column, and the roof structure;
the plurality of roof supports being linearly extended from the first column system to the second column system;
the plurality of roof supports being evenly distributed across an elevated end of the first column system, an elevated end of the at least one intermediate column system, and an elevated end of the second column system;
the plurality of roof supports being adjacently mounted onto the roof structure of the first column system, the roof structure of the at least one intermediate column system, and the roof structure of the second column system; and
the transparent solar roof being mounted onto the plurality of roof supports.

14. The truss-less greenhouse structure a transparent solar panel roof as claimed in claim 13, wherein the roof structure of the first column system being an arch body, and wherein the roof structure of the second column system being an arch body, and wherein the roof structure of the at least one intermediate column system being an arch body.

15. The truss-less greenhouse structure a transparent solar panel roof as claimed in claim 13 comprising:
the at least one intermediate column system comprising a support column, a left outer-brace, and a right outer-brace;
the roof structure being terminally mounted to the support column;
the roof structure being centrally positioned to the support column;
the left outer-brace and the right outer-brace being outwardly oriented away from the support column;
the left outer-brace being angularly mounted to the roof structure and the support column; and
the right outer-brace being angularly mounted to the roof structure and the support column.

16. The truss-less greenhouse structure a transparent solar panel roof as claimed in claim 13 comprising:
the roof structure comprising a left overhanging section, a right overhanging section, a central left section, and a central right section;
the central left section and the central right section being positioned adjacent to each other;
the left overhanging section being positioned adjacent to the central left section, opposite of the central right section; and
the right overhanging section being positioned adjacent to the central right section, opposite of the central left section.

17. The truss-less greenhouse structure a transparent solar panel roof as claimed in claim 13 comprising:
the plurality of roof supports comprising a set of left outer-supports, a set of left ridge-supports, a set of right outer-supports, and a set of right ridge-supports;
the roof structure comprising a left overhanging section, a right overhanging section, a central left section, and a central right section;
the set of left outer-supports being evenly distributed across the left overhanging section;
the set of left outer-supports being adjacently mounted the left overhanging section;
the set of right outer-supports being evenly distributed across the right overhanging section;
the set of right outer-supports being adjacently mounted the right overhanging section;
the set of left ridge-supports being evenly distributed across the central left section;
the set of left ridge-supports being retractably mounted the central left section;
the set of right ridge-supports being evenly distributed across the central right section; and
the set of right ridge-supports being retractably mounted the central right section.

18. The truss-less greenhouse structure a transparent solar panel roof as claimed in claim 13 comprising:
the transparent solar roof comprising a left fixed-paneled section, a right fixed-paneled section, a left retractable-paneled section, and a right retractable-paneled section;
the plurality of roof supports comprising a set of left outer-supports, a set of left ridge-supports, a set of right outer-supports, and a set of right ridge-supports;
the left fixed-paneled section being mounted to the set of left outer-supports;
the right fixed-paneled section being mounted to the set of right outer-supports;
the left retractable-paneled section being mounted to the set of left ridge-supports; and
the right retractable-paneled section being mounted to the set of right ridge-supports.

19. The truss-less greenhouse structure a transparent solar panel roof as claimed in claim 13 comprising:
a lateral frame;
a first transparent wall;
a second transparent wall;
a left transparent wall;
a right transparent wall;
the lateral frame comprising a first end-frame, a second end-frame, a left frame, and a right frame;
the first end-frame being externally mounted to the first column system;
the second end-frame being externally mounted to the second column system;
the first transparent wall being externally mounted to the first end-frame;
the second transparent wall being externally mounted to the second end-frame;
the left frame and the right frame being oppositely positioned of each other about the first column system;
the left frame being externally mounted to the roof structure of the first column system, the roof structure of the at least one intermediate column system, the roof structure of the second column system, the first end-frame, and the second end-frame;
the right frame being externally mounted to the roof structure of the first column system, the roof structure of the at least one intermediate column system, the roof structure of the second column system, the first end-frame, and the second end-frame;
the left transparent wall being externally mounted to the left frame; and
the right transparent wall being externally mounted to the right frame.

20. The truss-less greenhouse structure a transparent solar panel roof as claimed in claim 13 comprising:
at least one roll up door;
at least one man door;
a lateral frame;
the roll up door being integrated into the lateral frame; and
the man door being integrated into the lateral frame.
